(19) United States
(12) Patent Application Publication
(10) Pub. No.: US 2025/0224490 A1
(43) Pub. Date: Jul. 10, 2025

(54) RADAR AUTOFOCUS SYSTEM, APPARATUS, AND METHOD

(71) Applicant: TOCARO BLUE, LLC, Pensacola, FL (US)

(72) Inventors: Austin Gurley, Birmingham, AL (US); Kyle Kubik, Birmingham, AL (US)

(21) Appl. No.: 19/011,482

(22) Filed: Jan. 6, 2025

Related U.S. Application Data
(60) Provisional application No. 63/617,871, filed on Jan. 5, 2024.

(51) Int. Cl. G01S 7/40; G01S 13/937; G06N 20/00

(52) U.S. Cl. CPC G01S 7/40; G01S 13/937; G06N 20/00

(57) ABSTRACT

A method implemented by a radar system controller configured to be disposed on a marine vessel and interface with a marine radar system to predict a gain error is provided. The method may include receiving raw radar data, converting the raw radar data into processed radar data, applying the processed radar data to a radar gain prediction model to determine a gain error, and adjusting a gain setting value of the radar system as a feedback input to repeatedly adjust the operation of the radar system based on the gain error.

### CROSS-REFERENCE TO RELATED APPLICATIONS

This application claims the benefit of U.S. Provisional Application No. 63/617,871 filed on Jan. 5, 2024, the entire contents of which are hereby incorporated herein by reference.

### TECHNICAL FIELD

Example embodiments generally relate to electromagnetic signal detection technologies and, in particular, relate to radar technology.

### BACKGROUND

Radar (radio detection and ranging) systems have become commonplace on many marine vessels of a certain size, and such systems have proven to be useful for detecting objects on the water that are in the surrounding area of the vessel. The radar information provided to a pilot or operator of a vessel can be extremely helpful for navigation and collision avoidance at sea, particularly in low visibility conditions.

The raw information, or radar data, provided by a radar system can be plotted on a display screen to present the radar data to the operator. However, based on the current conditions and environment, modification to various settings is needed to “tune” the radar system to provide meaningful and accurate information to a user. One setting that is modified to tune the radar system is the gain. Modifications to a gain setting on a radar system can, in some respects, control filtering of the radar reflection signals to control the amount of noise that may be passed and presented to a user on a display. In many conventional radar systems, the gain is controlled by the user via a knob or the like while the user watches the display to determine an optimal value for the gain setting. Such manual control of the gain setting requires some degree of operational experience. Additionally, and likely more importantly, since a manual control is often involved, the ability to process the radar data for purposes other than raw presentation is limited since changes in the gain can affect the radar data that is available for analysis.

### BRIEF SUMMARY OF SOME EXAMPLES

According to some example embodiments, a gain model and autofocus radar (GMAR) system is described. The GMAR system may comprise a gain prediction model training processor and a marine autofocus radar system. The gain prediction model training processor may be configured to receive training radar data, receive truth data, and perform a machine learning training process to develop a radar gain prediction model based on the training radar data and the truth data. The marine detection system may be configured for use on a marine vessel, and the marine detection system may comprise a radar system and a radar system controller. The radar system may be configured to be disposed on the marine vessel and the radar system may be further configured to generate raw radar data based on transmitted radar signals and received radar reflection signals. The radar system controller may be configured to be operably coupled to the radar system. The radar system controller may be further configured to receive the raw radar data from the radar system, convert the raw radar data into processed radar data, apply the processed radar data to the radar gain prediction model to determine a gain error, and adjust a gain setting value of the radar system as a feedback input to repeatedly adjust the operation of the radar system based on the gain error. The gain setting value may affect content of the raw radar data by controlling amplification of the transmitted radar signals or filtering of the received radar reflection signals.

According to some example embodiments, a radar system controller is described. The radar system controller may be configured to be disposed on a marine vessel and interface with a marine radar system. The radar system controller may comprise an input configured to receive raw radar data from the radar system. The raw radar data may be based on transmitted radar signals and received radar reflection signals of the marine radar system. The radar system controller may also comprise an output configured to provide a gain setting value to the radar system to control a gain setting of the radar system. Additionally, the radar system controller may comprise a processor configured to receive the raw radar data from the radar system, convert the raw radar data into processed radar data, and apply the processed radar data to a gain prediction model to determine a gain error from the gain prediction model. The gain prediction model may have been generated via a machine learning process involving a convolutional neural network. The processor may be further configured to adjust a gain setting value of the radar system as a feedback input to repeatedly adjust the operation of the radar system based on the gain error. The gain setting value may affect content of the raw radar data by controlling amplification of the transmitted radar signals or filtering of the received radar reflection signals.

According to some example embodiments, a method implemented by a radar system controller configured to be disposed on a marine vessel and interface with a marine radar system to predict a gain error is provided. The method may comprise receiving, by a processor of the radar system controller, raw radar data from the radar system, converting the raw radar data into processed radar data, applying, by the processor, the processed radar data to a radar gain prediction model to determine a gain error, the radar gain prediction model having been generated via a machine learning process involving a convolutional neural network, and adjusting a gain setting value of the radar system as a feedback input to repeatedly adjust the operation of the radar system based on the gain error. The gain setting value may affect content of the raw radar data by controlling amplification of the transmitted radar signals or filtering of the received radar reflection signals.

### BRIEF DESCRIPTION OF THE SEVERAL VIEWS OF THE DRAWING(S)

Having thus described some embodiments in general terms, reference will now be made to the accompanying drawings, which are not necessarily drawn to scale, and wherein:

FIG. 1 illustrates an example gain and autofocus radar (GMAR) system according to some example embodiments;

FIG. 2A illustrates an example block diagram of a gain prediction model training processor according to some example embodiments;

FIG. 2B illustrates an example warped overhead view of radar data according to some example embodiments;

FIG. 2C illustrates an example view of radar data with a circular coordinate plane according to some example embodiments;

FIG. 2D illustrates an example distance gradient according to some example embodiments;

FIG. 2E illustrates an example processed radar data incorporating a distance gradient according to some example embodiments;

FIG. 2F illustrates an example processed radar data incorporating filler object features according to some example embodiments;

FIG. 3 illustrates an example network design according to some example embodiments;

FIGS. 4 and 5 illustrate graphs of training result convergence according to some example embodiments;

FIG. 6 illustrates a graph of confidence results according to some example embodiments;

FIG. 7 illustrates an example confusion matrix according to some example embodiments;

FIG. 8 illustrates a graph of a nonlinear relationship between expert labels and gain error feedback signals according to some example embodiments;

FIG. 9 illustrates a graph of feedback signals for different model formats according to some example embodiments;

FIG. 10 illustrates an example a feedback system if an autofocus classifier for model implementation according to some example embodiments;

FIGS. 11 and 12 illustrate graphs of gain response and estimated error with respect to time according to some example embodiments;

FIG. 13 illustrates an example method for training a radar gain prediction model according to some example embodiments;

FIG. 14 illustrates an example radar system controller according to some example embodiments; and

FIG. 15 illustrates an example method for predicting a gain error according to some example embodiments.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout.

As mentioned above, conventional radar systems used in marine applications may include, for example, manually-controlled settings (e.g., range and gain settings) for tuning the operation of the radar system based on user-perceived behavior (e.g., via a display) of the radar system. However, it would be beneficial to provide a reliable, automated approach for controlling the settings of the marine radar system, such as the gain setting, to implement an autofocus functionality that optimizes the gain setting. As such, according to some example embodiments, a radar system controller is described that uses a radar gain prediction model to determine a gain error that may be used to adjust a gain setting of the radar system in real-time operation. In doing so, the radar system controller may operate to provide an autofocus functionality for use when presenting radar data on a display (e.g., a multi-function display). Additionally or alternatively, the radar system controller, with its ability to determine a gain setting for a radar system, may also provide the gain-optimized data to another application for further analysis, such as, for example, object recognition analysis. As such, the reliable provision of gain-optimized radar data may be useful in a number of contexts.

According to various example embodiments, a marine radar system having an autofocus or auto-gain functionality is described. To render radar data on a display or process radar data for other applications, quality radar data is often needed. If the gain setting for a radar system is poorly adjusted for, for example, the current conditions or environment, the quality of the radar data will suffer and may provide useless or incomplete information. Conventional radar systems rely on a user to manually adjust the gain, as mentioned above, which can introduce inconsistencies associated with human error. According to some example embodiments, a machine or deep learning gain model may be generated, as further described herein, to facilitate an automated approach to dynamic adjustment of the gain of a marine radar system. According to some example embodiments, a deep convolutional network may be used to generate and improve the model.

In marine radar contexts, the availability of processing resources, power, and space may be limited. As such, according to some example embodiments, the implementation of a radar gain prediction model may be optimized for such limitations. For example, training data may be classified into one of five classes, which can operate to reduce to the processing needed to use the model for gain adjustment when implemented. According to some example embodiments, a global average pooling (GAP) approach may be utilized, as opposed to using fully connected top layers. For the model, based on the classes, to provide a continuous feedback signal, predication probabilities from the model, according to some example embodiments, may be used as a continuous measure of gain error, as opposed to forcing exact classifications.

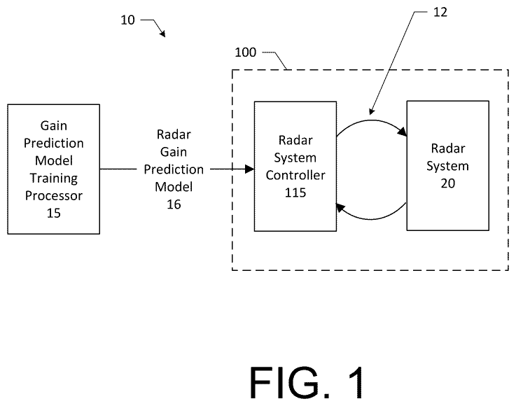

As shown in FIG. 1, a high-level block diagram of a gain and autofocus radar (GMAR) system 10 is provided, according to various example embodiments. In this regard, the GMAR system 10 may be comprised of components configured to develop a radar gain prediction model that may be used for making gain setting predictions that can be used by a radar system. In this regard, the GMAR system 10 may comprise a gain prediction model training processor 15, and an autofocus radar system 100. The autofocus radar system 100 may comprise a radar system controller 115 and a radar system 20. As further described herein, the gain prediction model training processor 15 may be configured to train a radar gain prediction model 16 for use by the radar system controller 115 to automatically determine a gain setting for the radar system 20. The gain setting may be based on a gain error that is determined using a feedback process 12.

As such, the gain prediction model training processor 15 may comprise or be embodied by a processing device or system configured to generate or improve the radar gain prediction model 16 based on radar training data and truth data. The radar system controller 115 may also comprise or be embodied by a processing device or system configured to use the radar gain prediction model 16 by applying newly acquired radar data from the radar system 20 to the radar gain prediction model 16 to determine a gain error and an associated gain setting. In this regard, the radar system controller 115 may be configured to control the operation of the radar system 20, at least with respect to automatically providing a gain setting value for use by the radar system 20. Using the gain setting value, the radar system 20 may capture newly acquired radar data, which may be evaluated in the feedback process 12 to determine if adjustments to the gain setting value are needed. According to some example embodiments, the radar system controller 115 may include a gain prediction model training processor 15 for improving a previously trained radar gain prediction model 16.

The radar system 20 may comprise a radar antenna, which may be an antenna array and circuitry configured to transmit radar signals and receive radar reflection signals that correspond to the transmitted radar signals in a controlled manner by the radar system controller 115. Techniques such a time-of-flight, angle of arrival, and the like may be used to analyze the radar reflection signals to determine if the radar reflection signals are indicative of the presence of an object or target. In other words, based on characteristics of the radar reflection signals information such as relative location of a target can be determined. According to some example embodiments, the radar system 20 may perform some processing of the raw radar data, or such processing may be performed by the radar system controller 115. Example processing of the raw radar data may include processing to correct for Doppler shift, certain types of noise filtering, and the like. Accordingly, the GMAR system 10, for example, may be configured to generate and utilize the radar gain prediction model 16. Additionally, according to some example embodiments, the radar gain prediction model 16 may be further optimized in real-time during utilization by the radar system controller 115.

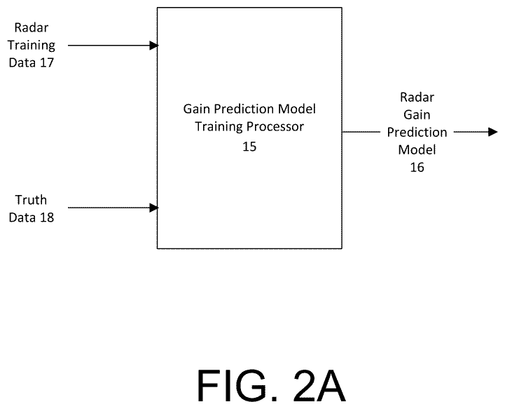

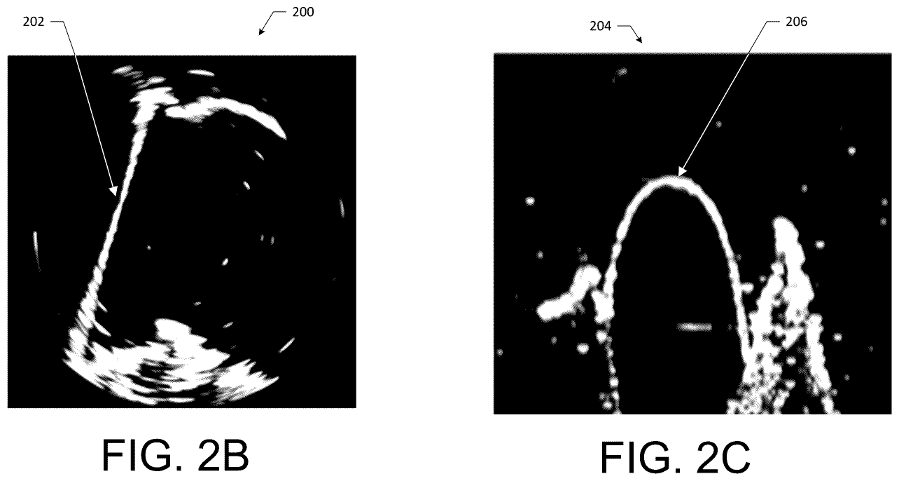

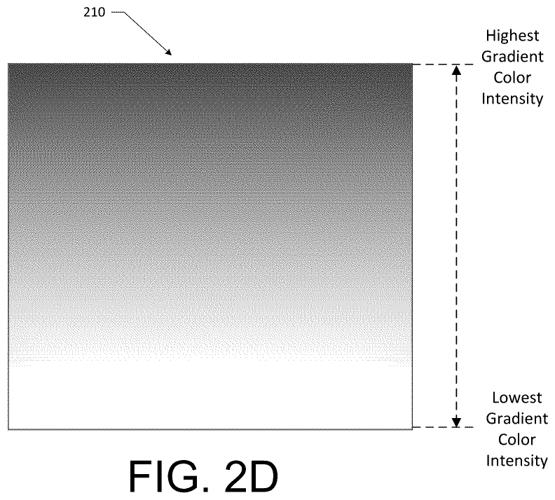

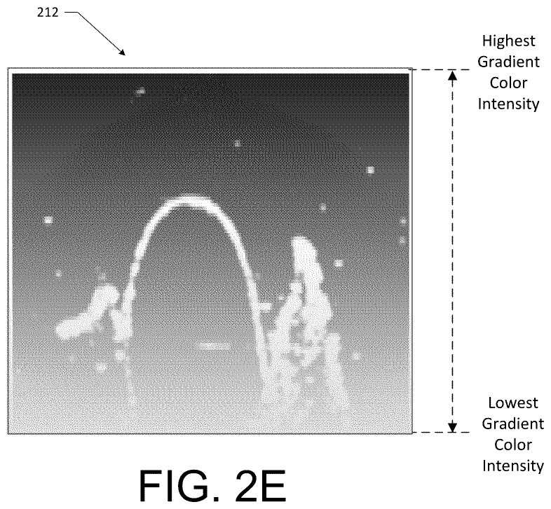

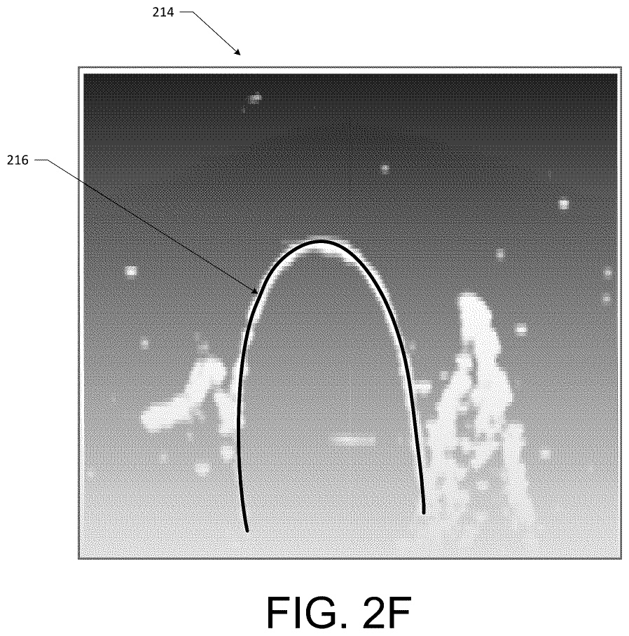

Referring now to FIG. 2A, an example block diagram of the gain prediction model training processor 15 is shown with inputs and an output. In this regard, the gain prediction model training processor 15 may receive radar training data 17 and truth data 18. The gain prediction model training processor 15 may output, based on the radar training data 17 and the truth data 18, the radar gain prediction model 16.

The gain prediction model training processor 15 may be implemented as processing circuitry configured to perform the functionalities described with respect to the gain prediction model training processor 15 provided herein. In this regard, the gain prediction model training processor 15 may include a processing device (e.g., a microprocessor) configure to execute software instructions stored in, for example, a memory device of the gain prediction model training processor 15. The processing device, additionally or alternatively, may be may be implemented as a hardware configured device that performs the functionalities described with respect to the gain prediction model training processor 15 provided herein, such as, for example, a field programmable gate array (FPGA), an application specific integrated circuit (ASIC), or the like.

As mentioned above, the radar gain prediction model 16 may be used to determine a gain error for use in adjusting a gain setting of a radar system, such as, for example, radar system 20. The gain setting, according to some example embodiments, controls an amount of information incorporated into the radar data provided by a radar system. For example, in higher seas, the peaks of the waves can be weak radar targets that are indicated by a radar reflection signal of a radar system. By adjusting the gain setting down, such weak radar targets can be eliminated from the radar data, since such targets may be considered false positives. However, in some instances, such as when a kayak or canoe is in range of the radar system, a similar weak radar target may occur for the kayak or canoe. The difference between the radar targets for a peak of a wave and a kayak or canoe may be negligible when considered on a display of a conventional radar system. As such, in such a situation, adjusting the gain setting to eliminate such weak radar targets (for example, by reducing the amplification of the transmitted radar signals or filtering weak or low power received radar reflection signals) may result in the loss of useful and important information. As such, according to some example embodiments, one principle of the radar gain prediction model 16 may be that the gain error and the ultimate gain setting is set to a value that includes all false positives in the radar data (i.e., the raw radar data), since, for example, other subsequent processing may be performed to eliminate or otherwise address the false positives.

The radar gain prediction model 16 may be developed or generated by the gain prediction model training processor 15, according to various example embodiments, in a variety of ways. According to some example embodiments, the machine learning and convolutional neural network may be used to develop or “train” the radar gain prediction model. To do so, according to some example embodiments, training radar data may be captured for analysis an input to the machine learning training process. In this regard, the training radar data, for example, may be captured at a known location with known environmental features for radar targets. Such known environmental features or objects (e.g., shoreline, channel markers, or the like) may appear a radar targets in the radar training data that is captured. Moreover, according to some example embodiments, the radar training data may be captured with, for example, the settings of the radar system sweep through their respective ranges to perform a setting sweep operation. For example, the radar training data may be captured with the gain set across a range of settings. The range or distance setting may also be swept across a number of settings. Such changes in the settings may be correlated with the radar training data, such that a link between the settings used to capture the particular data can be leveraged in the training process.

According to some example embodiments, the radar training data may be captured and evaluated as multi-dimensional image frames (as opposed to single dimension scanlines). The image frames may be evaluated as image-like inputs that may be defined with respect to a plurality of definition channels that incorporate encoded information into the image frames. For example, according to some example embodiments, the image frames may comprise three channels. In this regard, a first channel may be a grayscale channel for scanline data, a second channel may be a red-green-blue (rgb) three-color channel that incorporates ranging information, and a third channel may be a red-green-blue-alpha (rgba) four-parameter channel that provides filler information. These data channels may be considered for feature shaping to condition the radar data into the image frames prior to being used to develop the model. Moreover, these data channels may be processed to generate the image frames used as inputs to the model generation process performed by the gain prediction model training processor 15.

According to some example embodiments, the first channel may be raw scanline radar data. In this regard, an array of scanlines may be compiled into a data structure of one or more image frames as the first channel. The scanline radar data may be structured in a variety of ways. For example, according to some example embodiments, the scanline radar data may be submitted to a warping process to structure the data for consideration and visualization in an overhead view. As shown in FIG. 2B, a conventional warped overhead view 200 of a radar data scanline is shown. Notably, the overhead view 200 of a radar data scanline includes a feature 202, which is indicative of a physical bridge structure.

Rather than subjecting the scanline radar data to a warping process, a circular data structure may be utilized for the scanline radar data. In this regard, according to some example embodiments, the raw scanline data may be organized in such a circular data structure, or a circular conversion may be performed. FIG. 2C shows the same scanline radar data in the view 204, where the scanline data is organized in a circular data structure. The circular data structure may include at least one dimension in which the data that is in a circular coordinate plane relative to an origin at the antenna of the radar system. According to some example embodiments, the circular data structure may comprise a polar coordinate system. As indicated in the view 204, the linear bridge feature 202 from the overhead view 200 has a curvature in the view 204 of the radar data scanline presented with the circular data structure. According to some example embodiments, the use of the circular data structure may realize processing efficiencies since, for example, the data warping process is not necessary and consideration of the rotation invariance introduced by the warping process should be considered. Further, according to some example embodiments, since the radar data scanline is a singular source for this channel, the first channel data stream may be implemented as a single layer input, for example, with intensity encoded from 0 to 255 (i.e., one byte per pixel).

According to some example embodiments, the second channel may encode range information for use in developing the radar gain prediction model 16. According to some example embodiments that implement a convolutional network, such as a convolutional neural network, the inherent translation invariance may be considered. As such, according to some example embodiments, for each radar data scanline, a distance factor may be encoded, which can assist in the development of a robust model. To encode such range information into the data, a gradient that is range dependent may be introduced to the data. In this manner, the removal or subtraction of the gradient component would provide the original data in isolation, and the value of the gradient component would be indicative of a distance or range of the data point from the radar antenna. In this regard, according to some example embodiments, a color element may be used to add the gradient where the color intensity or shade is indicative of the distance. For example, the applied gradient may be scaled across a range (e.g., from 0 to 255) from nearest to farthest data. According to some example embodiments, the nearest data may be presented at, for example, the top of the image view and the farthest data may be presented at the bottom of the image view. In this regard, FIG. 2D illustrates an example distance gradient 210 that may be added to the radar data. Further, FIG. 2E illustrates the data from view 204 with the distance gradient 210 incorporated to form data view 212. As can be seen, the highest gradient color intensity is closest to the radar antenna (at the top) and the lowest color intensity is farthest from the radar antenna (at the bottom).

According to some example embodiments, a third channel of information may also be introduced into the radar data as a filler channel for use in developing the radar gain prediction model 16. In this regard, such filler information may be introduced, according to some example embodiments, so that the resultant radar data is compatible for use with image processing tools and for future model improvement. In this regard, the filler channel may introduce information regarding the known location and shape of objects within the radar training data. In this regard, according to some example embodiments, pixel locations of corresponding to such objects (e.g., channel markers, bridges, shorelines, etc.) may be combined with the radar data. For example, the third, filler channel may introduce, as shown in FIG. 2F, the feature 216, which is a physical bridge structure at a known location and having a known shape as indicated in the view 214 of the radar data. This feature 216 may, for example, be stored in association with the radar data on a separate layer. As such, global positioning system (GPS)-oriented marine map data of the know objects indicating fixed-position object targets within a range of the radar system can be incorporated. Thus, the view 214 incorporates all three channels of information described above. It is noted, however, that according to some example embodiments, all three channels need not be utilized and some example embodiments may use only one or two of the channels to encode further information into the radar data that is used for training.

According to some example embodiments, the feature-shaped radar data (e.g., resulting from the one or more of the three channels described above) may be subjected to a dimension reduction process by the gain prediction model training processor 15. The dimension reduction process may be configured to ensure that certain radar target data is not lost during downscaling of the radar training data 17. Such loss of information may result in the loss of radar targets for small objects (e.g., kayaks, canoes, jet skis, etc.). However, due to processing resource constraints, downscaling may be necessary to maintain model implementation speed and updates to the model. As such, the dimension reduction process may be performed, according to some example embodiments, the resulting image frames from the feature shaping may be reduced in size by maintaining a maximum value associated with each radar target (e.g., instance of a discrete non-noise reflected signal), even if nearby and adjacent information is lost during the downscaling. As such, no radar target, according to some example embodiments, is completely lost as a result of downscaling. According to some example embodiments, the dimensions of the model input may be determined to balance loss of information with robustness of the model. In this regard, according to some example embodiments, an image frame size of 180×180 pixels has proven to have an effective balance between size and robustness. According to some example embodiments, further data augmentation may be performed to condition the radar training data 17 for model development.

Based on the foregoing, the radar training data 17 may be converted from raw radar data to processed radar data for use in developing the radar gain prediction model 16. Such processed radar data may be used to initially develop the radar gain prediction model 16 or to improve the radar gain prediction model 16 when the model is in use to determine gain error outputs on, for example, a marine vessel.

With the radar training data 17 and the truth data 18 provided to the gain prediction model training processor 15 and now processed to from processed radar data, as described above, a model development process can be performed to generate or improve the radar gain prediction model 16. As mentioned above, a convolutional neural network may be utilized in the generation of the radar gain prediction model 16. In some example embodiments, a simple categorical cross-entropy approach may be used for model training, where, for example, regression is not considered until post-processing. Moreover, for example, the gain prediction model training processor 15 may implement machine learning involving a convolutional neural network to ascertain data relationships to construct the model. Further, techniques such as classification, dimensionality reduction, regression, clustering, and the like to construct the radar gain prediction model 16.

With respect to the outputs of the radar gain prediction model 16, the complexity of the model, according to some example embodiments, may be managed for the limited processing resources available in marine applications by defining a finite number of gain error outputs from the model 16. In this regard, according to some example embodiments, five output options as gain errors from the radar gain prediction model 16 may be defined as provided in Table 1 below.

TABLE 1

| Index | Class | Gain Response | Tracking |
|---|---|---|---|
| 0 | Very Low | Increase ~10% | Allowed |
| 1 | Low | Increase ~2% | Allowed |
| 2 | OK | No change | Allowed |
| 3 | High | Decrease ~2% | Allowed |
| 4 | Very High | Decrease ~10% | Disabled |

Describing Table 1, the output index may be a unique identifier for the output, with the value being, for example, 0-4. The class of the output may be the name used to reference the condition of the input processed radar data. The gain response may be also be referred to as the gain error and may indicate the adjustment to the gain setting that should be made as result of the implementing the radar gain prediction model 16. Additionally, the output may include a value or flag to indicate whether the input processed radar data may be used for tracking and object detection by another application. In this regard, for example, if the gain setting is Very High, then the processed radar data should not be used for tracking and object detection. Thus, the gain response may indicate a desirable change to the gain setting to improve the quality of the information being captured by the radar system. While the gain errors are set to about 2% and about 10% respectively, it is understood that any values for such outputs may be used (e.g., 5% and 12%, respectively).

Thus, according to some example embodiments, the radar gain prediction model 16 may be trained to detect the need for five different levels of gain error for autofocusing. As described herein, the output in the form of a gain error is used to modify that gain setting, which forms a feedback loop for optimizing the gain for the radar system. The radar gain prediction model 16 may classify, for example, the five output options as independent discrete outputs. However, a continuous scale could be implemented. Additionally, the radar gain prediction model 16 may also be defined to have a bias towards increasing the gain setting. In other words, if the radar gain prediction model 16 makes a prediction that, for example, would place the output between an gain error of Increase ˜2% and Increase ˜10%, the radar gain prediction model 16 may be defined to provide the Increase ˜10% output. This aligns with the explanation above indicating that it may be important to capture more information on radar targets, particularly for object tracking and detection applications, where weak targets may be, for example, other vessels and not merely wave peaks. As such, the bias towards increasing the gain setting or a positive gain error may operate to reduce the impact of a non-continuous scale output implementation. The radar gain prediction model 16's confidence may show that the model has been defined to effectuate this concept.

With respect to the design of the network used to generate the radar gain prediction model 16, a small and fast, fully convolutional network may be employed for edge computing. According to some example embodiments, a global average pooling (GAP) layer may be implemented in such small convolutional networks to achieve desirable convergence. In this regard, the use of GAP, as opposed to fully connected layers significantly reduces the trainable parameter count (e.g., on the order of 1e6 to 1e7 depending on the fully connected layer size). Moreover, the input may be converted from integer to floating point within the model, and therefore an 8 bit grayscale or 24 bit RGB image may be input directly into the network. The output may provide class confidence and may be trained against one-hot encoded labels for the outputs. Convolutional layers may use separable convolution with no loss in accuracy during training to further decrease computational cost (e.g., realizing a reduction of about 82%).

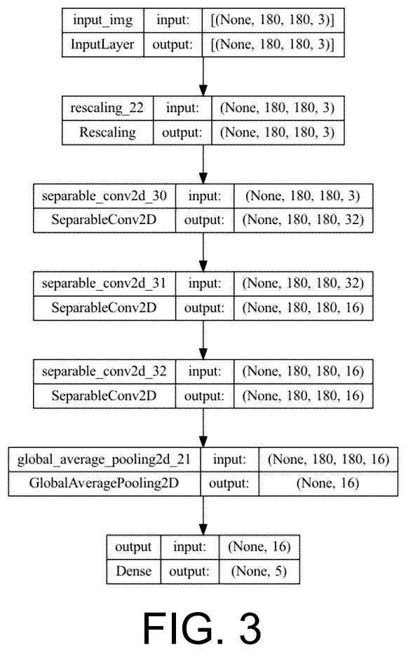

The resulting network design 300 for the radar gain prediction model 16, according to some example embodiments, is shown in FIG. 3. As shown, the network design 300 includes operation involving the input image, rescaling, dimensional conversion, and global average pooling to generate the output model.

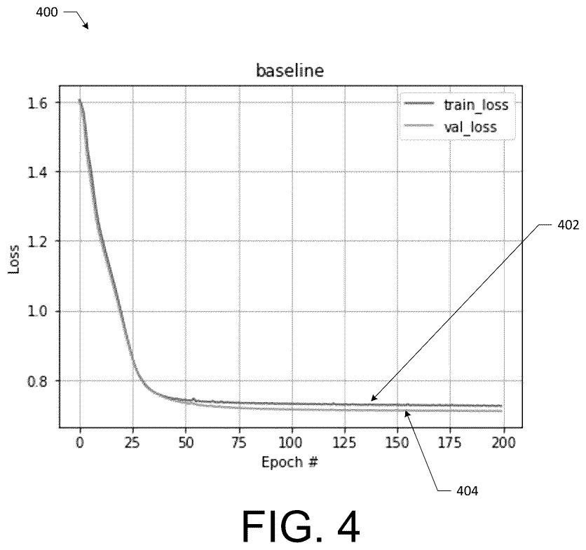

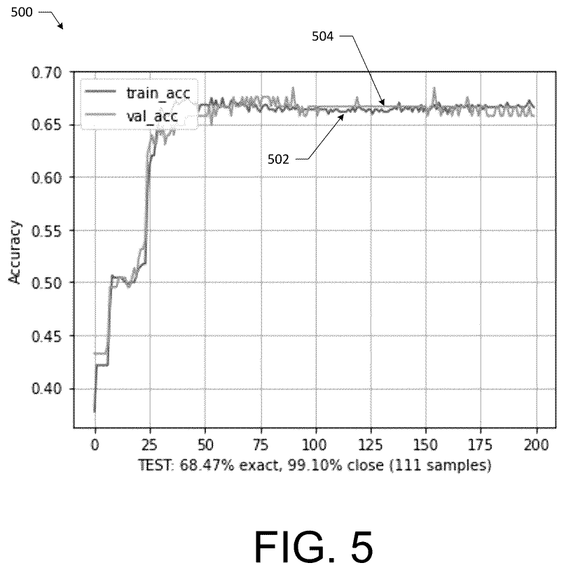

According to some example embodiments, an example training process will now be described based on an actual implementation with reference to FIGS. 4-10. In this regard, an example radar gain prediction model 16 may be implemented in Keras and trained using categorical cross-entropy loss and an adaptive moment estimation optimizer. With the dataset of 600 samples, good convergence was achieved in approximately 40 epochs with minimal overfitting. Such convergence can be seen in the graphs 400 and 500 of the FIGS. 4 and 5, respectively, with train_loss 402, val_loss 404, train_acc 502, and val_acc 504.

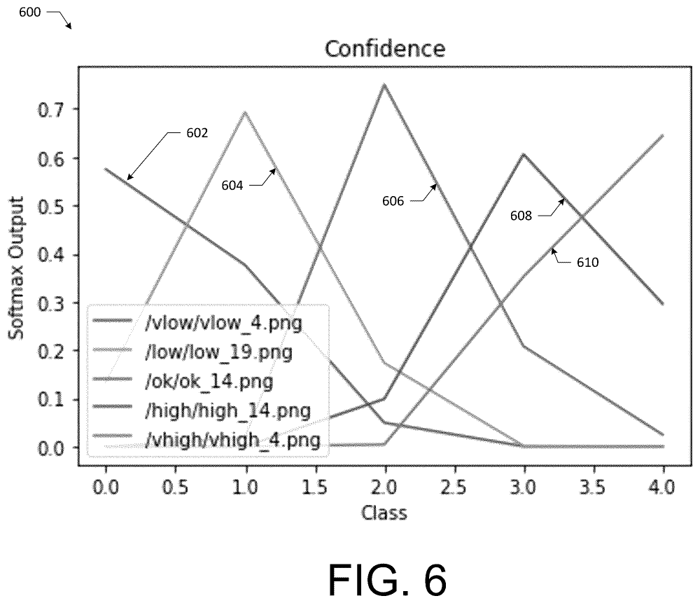

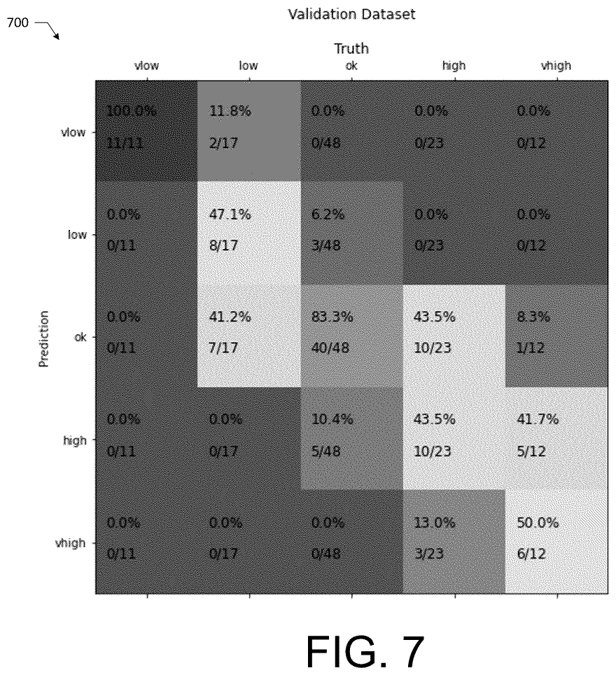

Since the output classes are arranged in a meaningful way (from low to high), it is valuable for the model to make predictions that are close if not exact, which provides some robustness, since the hand-labelled classes may be subjective for a radar expert who labels them visually with limited context. To evaluate this nearness, two forms of accuracy for the model 16 may be defined, i.e., exact predictions and close predictions. Exact predictions occur when the prediction matches the truth label, and close predictions occur when the prediction is within one class index of the truth label in consideration of the indices of Table 1. Accordingly, for exact predictions, the model 16 operated to achieve 68.47% accuracy and for close predictions, the model 16 operated to achieve 99.10% accuracy. The smooth scaling can be seen in the graph 600 of FIG. 6, which illustrates confidence results and indicating that the model 16 embeds some degree of ordering between the classes of outputs, as indicated by vlow/vlow 602, low/low 604, ok/ok 606, high/high 608, and vhigh/vhigh 610. FIG. 7 provides a related confusion matrix 700 for the validation dataset.

With respect to resource utilization, in an embedded hardware implementation with limited computing resources, ablation testing showed that grayscale 180×180×1 image frames (i.e. first channel/scanline data only, no second channel/range, or third channel/filler) may be the minimum practical input size that makes accurate class predictions in the test data. After rescaling raw scanline data to this 180×180×1 size, the model 16 based on the network design provided herein has only 1406 parameters and requires 473,504 floating-point operations per inference. If implemented on a microcontroller like an ARM Cortex M4F at 64 MHZ, execution time is estimated to be 22 milliseconds per inference. On a single-board computer such as Intel N5105 at 2 GHZ, execution time is estimated to be 24 microseconds. Such times are far below typical radar revolution rates (0.4 Hz to 1.0 Hz), showing that this level of model complexity may be well suited for practical implementation in a radar system controller.

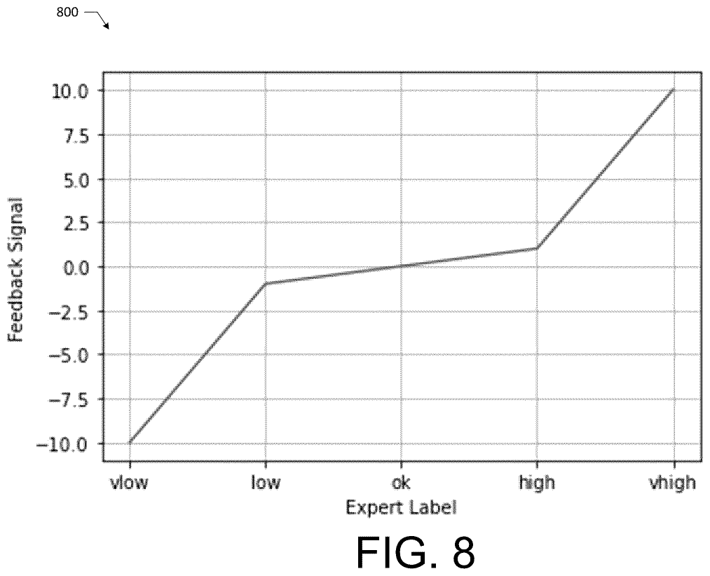

The model 16 may be exported to an open neural network exchange format for implementation. Initially stepwise control logic following the “Gain Response” of Table 1 was used. However, the example model in this implementation was found not to provide a good signal for feedback during control. The expert labeling process tended to leave a wide margin of error for labeling images that had ‘OK’ gain, and, as such, the radar system controller may leave the gain unmodified even when, for example, an expert could determine that small adjustments would be an improvement. This may have been caused by the fact that the expert considered a wide range of gains to be ‘OK’, which lead to a nonlinear relationship between labels and best feedback signal as shown in the graph 800 of FIG. 8.

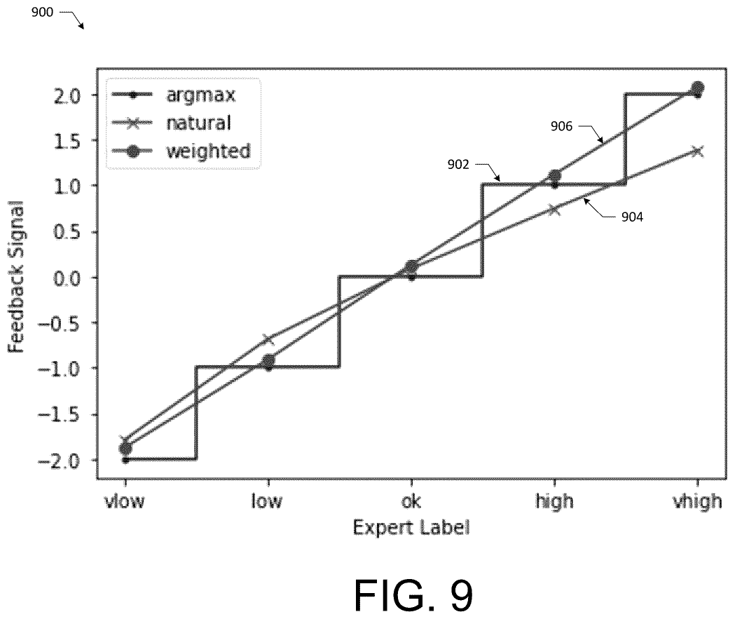

Thus, to prevent the radar system controller from stalling when the model 16 predicts (categorically) that the gain is ‘OK’, the output probabilities from the model 16 may be used to properly scale the labels and to create a smooth relationship between class output and feedback signal. Considering the prediction y_{pred}∈ [symbol] ₅ and a weight vector w∈ [symbol] ₅, an error signal e may be defined as e=Σwy_{pred}. A similar effect may have been created by training a regression model, but the approach provided herein preserves the ability to train against class labels using categorical cross-entropy. Using weights w=[−2.0, −1.5, 0.0, 1.5, 4.0] and applying the model to the validation set demonstrates that this weighting creates a strong feedback signal as indicated in the graph 900 of FIG. 9 for argmax 902, natural 904, and weighted 906 as the feedback signal provided by the different formats. As such, according to some example embodiments, the weighting matrix may be tuned after each significant update to the training datasets.

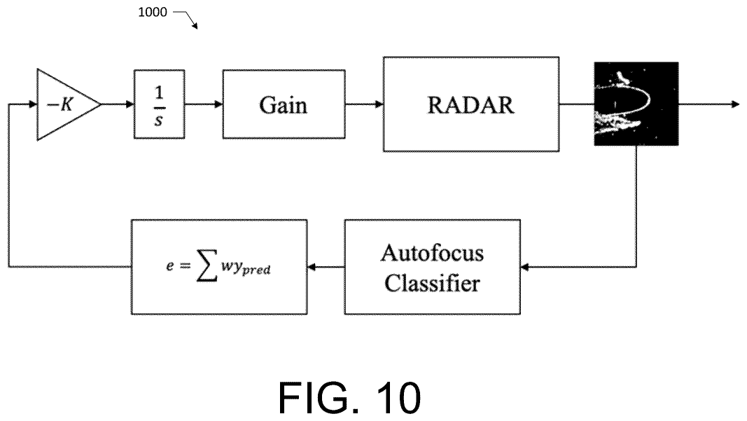

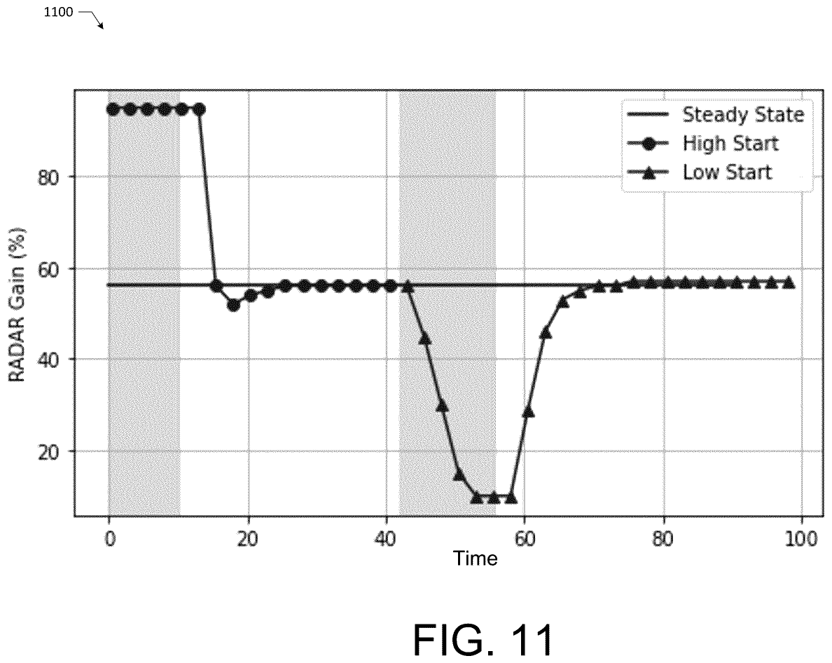

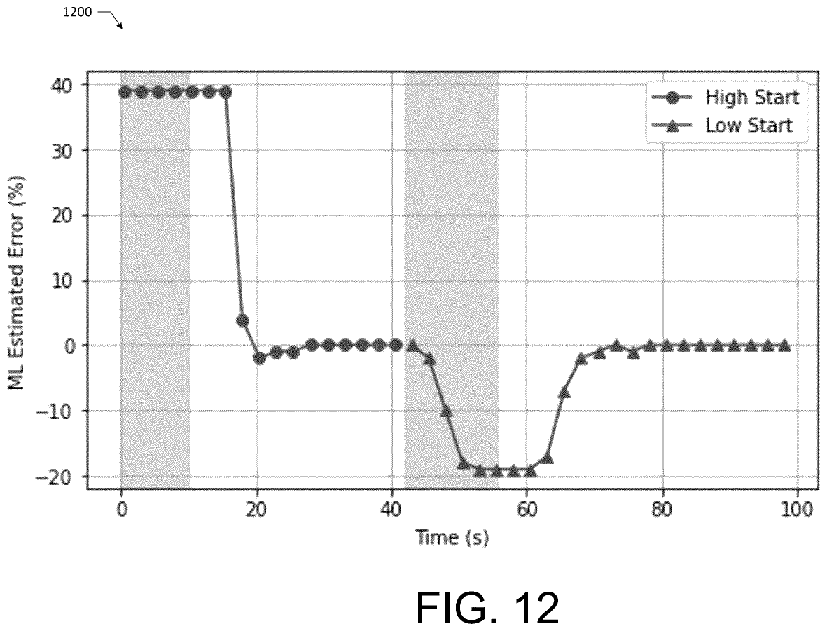

Testing was performed with a Garmin xHD RADAR in Pensacola Bay. The model 16 was implemented in a feedback control loop with the radar system as shown in feedback controller configuration 1000 of FIG. 10. In this implementation setting K=10 and an initial gain of 50% provided good auto-focus results with little overshoot. The gain may be limited to stay within 15%<gain <85% to prevent poor control due to integrator windup in exceptional conditions. As shown in the graphs 1100 and 1200 of FIGS. 11 and 12 respectively, the feedback controller configuration 1000 may be implemented to drive the same level regardless of whether the gain stated at a high value or a low value.

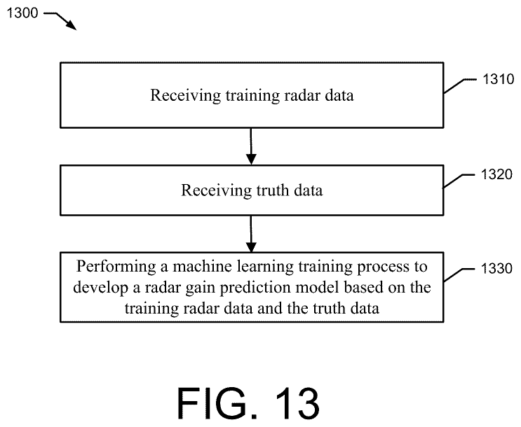

Having described various example embodiments and specific implementations, FIGS. 13-15 will now be described which illustrate methods, apparatuses, and systems for implementing some of the example embodiments herein.

In this regard, FIG. 13 illustrates a block diagram 1300 of an example training method for a radar gain prediction model, according to some example embodiments. According to some example embodiments, the example method may be implemented by the gain prediction model training processor 15 to train the initial model or by radar system controller 115 to improve an existing model.

In this regard, according to some example embodiments, the example method may comprise, at 1310, receiving training radar data, and, at 1320, receiving truth data. According to some example embodiments, the radar training data and the truth data may be combined in accordance with one or more channels to form processed radar data for use in generating or improving the model. According to some example embodiments, the processed radar data may be defined with respect to a coordinate system having at least one circular-defined dimension. According to some example embodiments, the truth data may be expert assessments of image frames of radar training data to be used as examples for convergence and generation of the model. According to some example embodiments, the example method may further comprise, at 1330, performing a machine learning training process to develop a radar gain prediction model based on the training radar data and the truth data.

According to some example embodiments, the truth data may be based on classifications of a plurality of image frames of the training radar data. According to some example embodiments, each image frame of the training radar data may be classified as being in one of five gain assessment classes, and each gain assessment class may have a respective gain adjustment response for use in performing the machine learning training process to develop the radar gain prediction model. According to some example embodiments, the training radar data may be generated by sweeping settings (e.g., gain and ranges settings) of the radar system over respective ranges, including the gain setting value, during capture of the training radar data and logging correlated settings of the radar systems.

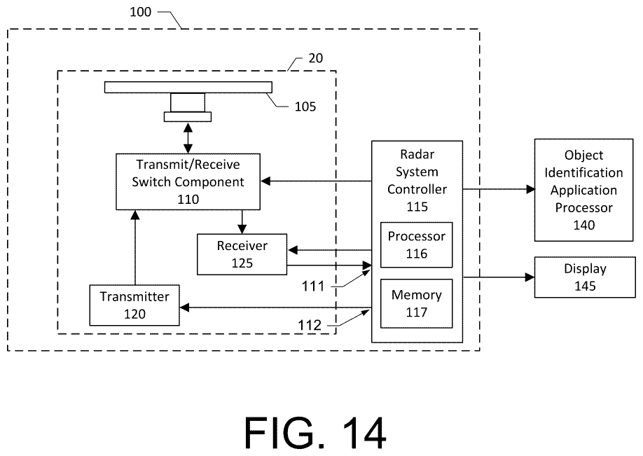

Now referring to FIG. 14, another example embodiment of the autofocus radar system 100 is shown as a block diagram, which may be implemented in a marine context. The autofocus radar system 100 may comprise a radar system 20 and a radar system controller 115. In general, the radar system 20 may be configured to generate raw radar data based on transmitted radar signals and received radar reflection signals. The radar system 20 may comprise a radar antenna 105, a transmit/receive switch component 100, a transmitter 120, and a receiver 125. The radar antenna 105 may be implemented, for example, as a rotatable antenna array. The radar antenna 105 may interface with the transmitter 120 and the receiver 125 via the transmit/receive switch component 110. The transmit/receive switch component 110 may be controllable to connect the radar antenna 105 with either the transmitter 120 or the receiver 125 to either transmit radar signals or receive radar signal reflections.

The radar system controller 115 may be implemented as processing circuitry configured to perform the functionalities described with respect to the radar system controller 115 described herein. In this regard, the gain prediction model training processor 15 may include a processor 116 as a processing device (e.g., a microprocessor) configured to execute software instructions stored in, for example, a memory 117. The processor 116, additionally or alternatively, may be may be implemented as a hardware configured device that performs the functionalities described with respect to the radar system controller 115 provided herein, such as, for example, a field programmable gate array (FPGA), an application specific integrated circuit (ASIC), or the like.

The radar system controller 115 may be configured to be operably coupled to the radar system 20 to, for example, receive raw radar data from the radar system 20. According to some example embodiments, the radar system controller 115 may comprise an input 111 and an output 112. According to some example embodiments, the radar system controller 115 may be configured to interface with a display 145, which may be a multi-function display. Additionally or alternatively, the radar system controller 115 may be configured to interface with an object identification application processor 140, which may be configured to implement, for example, object (e.g., marine vessel) tracking and identification. In this regard, the radar system controller 115 may provide data based on the raw radar data provided by the radar system 20 to the display 145 for rendering to a user or to the object identification application processor 140 for processing to perform tracking and identification.

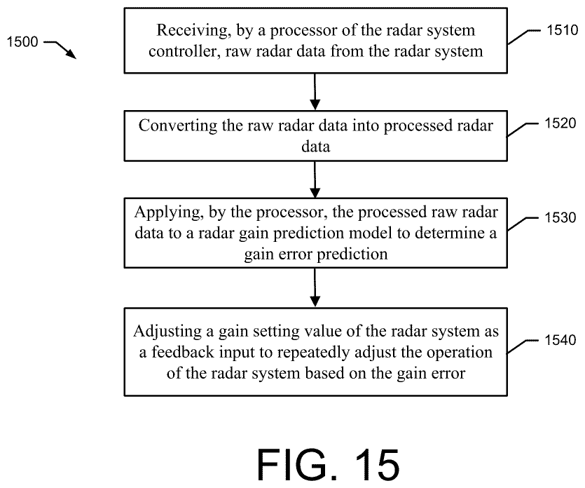

According to some example embodiments, the radar system controller 115, via the processor 116, may be configured to implement the example method illustrated in the flow chart 1500 of FIG. 15. In this regard, the radar system controller 115 and the processor 116 may be configured to, at 1510, receive raw radar data from the radar system. At 1520, the radar system controller 115 and the processor 116 may be configured to convert the raw radar data into processed radar data, and, at 1530, apply the processed radar data to the radar gain prediction model to determine a gain error. According to some example embodiments, the gain error may be defined as one or finite number (e.g., five) output options. Further, at 1540, the radar system controller 115 and the processor 116 may be configured to adjust a gain setting value of the radar system as a feedback input to repeatedly adjust the operation of the radar system based on the gain error. According to some example embodiments, the gain setting value may affect content of the raw radar data by controlling amplification of the transmitted radar signals or filtering of the received radar reflection signals.

According to some example embodiments, the radar system controller 115 may be further configured to receive a second set of raw radar data from the radar system 20, determine a second gain error, and adjust the gain setting value of the radar system 20 based on the second gain error. Additionally or alternatively, according to some example embodiments, the radar system controller 115 may be further configured to adjust the gain prediction model, prior to applying second processed radar data to the gain prediction model, using a convolution neural network. Additionally or alternatively, according to some example embodiments, the radar system controller 115 may be further configured to adjust the gain prediction model, prior to applying second processed radar data to the gain prediction model, based on global positioning system (GPS)-oriented marine map data indicating fixed-position object targets within a range of the radar system. Additionally or alternatively, according to some example embodiments, the radar system controller 115 may be configured to convert the raw radar data into the processed radar data, the processed radar data being defined with respect to a coordinate system having at least one circular-defined dimension. Additionally or alternatively, according to some example embodiments, the radar system controller 115 may be configured to convert the raw radar data into the processed radar data, the processed radar data being formatted as multi-dimensional image frames converted from an array of radar scanlines. Additionally or alternatively, according to some example embodiments, the radar system controller 115 may be configured to perform object identification based on the processed radar data. Additionally or alternatively, according to some example embodiments, the radar system controller 115 may be configured to receive a plurality of known feature locations for known objects, and apply the processed radar data to the gain prediction model to determine the gain error from the gain prediction model. The gain prediction model may be constructed to determine the gain error to capture radar targets in addition to radar targets for the known objects.

Many modifications and other example embodiments in addition to those set forth herein will come to mind to one skilled in the art to which these embodiments pertain having the benefit of the teachings presented in the foregoing descriptions and the associated drawings. Therefore, it is to be understood that the embodiments are not to be limited to those disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed is:

1. A gain model and autofocus radar (GMAR) system, the GMAR system comprising:
a gain prediction model training processor configured to:
receive training radar data;
receive truth data;
perform a machine learning training process to develop a radar gain prediction model based on the training radar data and the truth data; and
a marine autofocus radar system for use on a marine vessel, the marine autofocus radar system comprising:
a radar system configured to be disposed on the marine vessel, the radar system being further configured to generate raw radar data based on transmitted radar signals and received radar reflection signals;
a radar system controller configured to be operably coupled to the radar system, the radar system controller being further configured to:
receive the raw radar data from the radar system;
convert the raw radar data into processed radar data;
apply the processed radar data to the radar gain prediction model to determine a gain error; and
adjust a gain setting value of the radar system as a feedback input to repeatedly adjust the operation of the radar system based on the gain error, wherein the gain setting value affects content of the raw radar data by controlling amplification of the transmitted radar signals or filtering of the received radar reflection signals.

2. The GMAR system of claim 1, wherein the radar system controller is further configured to receive a second set of raw radar data, determine a second gain error, and adjust the gain setting value of the radar system based on the second gain error.

3. The GMAR system of claim 2, wherein the radar system controller is further configured to adjust the gain prediction model, prior to applying second processed radar data to the gain prediction model, using a convolution neural network.

4. The GMAR system of claim 2, wherein the radar system controller is further configured to adjust the gain prediction model, prior to applying second processed radar data to the gain prediction model, based on global positioning system (GPS)-oriented marine map data indicating fixed-position object targets within a range of the radar system.

5. The GMAR system of claim 1, wherein the radar system controller is configured to convert the raw radar data into the processed radar data by at least converting the raw radar data into the processed radar data, the processed radar data being defined with respect to a coordinate system having at least one circular-defined dimension.

6. The GMAR system of claim 1, wherein the radar system controller is configured to convert the raw radar data into the processed radar data by at least converting the raw radar data into the processed radar data, the processed radar data being formatted as multi-dimensional image frames converted from an array of radar scanlines.

7. The GMAR system of claim 1, wherein the truth data is based on classifications of a plurality of image frames of the training radar data.

8. The GMAR of claim 7, wherein each image frame of the training radar data is classified as being in one of five gain assessment classes, each gain assessment class having a respective gain adjustment response for use in performing the machine learning training process to develop the radar gain prediction model.

9. The GMAR system of claim 1, wherein the training radar data is generated by sweeping settings of the radar system over respective ranges, including the gain setting value, during capture of the training radar data and logging correlated settings of the radar systems.

10. The GMAR system of claim 1, wherein the radar system controller is further configured to perform object identification based on the processed radar data;
wherein the radar system controller is configured to:
receive a plurality of known feature locations for known objects; and
apply the processed radar data to the gain prediction model to determine the gain error from the gain prediction model, the gain prediction model being constructed to determine the gain error to capture radar targets in addition to radar targets for the known objects.

11. A radar system controller configured to be disposed on a marine vessel and interface with a marine radar system, the radar system controller comprising:
an input configured to receive raw radar data from the radar system, the raw radar data being based on transmitted radar signals and received radar reflection signals;
an output configured to provide a gain setting value to the radar system to control a gain setting of the radar system; and
a processor configured to:
receive the raw radar data from the radar system;
convert the raw radar data into processed radar data;
apply the processed radar data to a gain prediction model to determine a gain error from the gain prediction model, the gain prediction model having been generated via a machine learning process involving a convolutional neural network; and
adjust a gain setting value of the radar system as a feedback input to repeatedly adjust the operation of the radar system based on the gain error, wherein the gain setting value affects content of the raw radar data by controlling amplification of the transmitted radar signals or filtering of the received radar reflection signals.

12. The radar system controller of claim 11, wherein the processor is further configured to receive a second set of raw radar data, determine a second gain error, and adjust the gain setting value of the radar system based on the second gain error.

13. The radar system controller of claim 12, wherein the processor is further configured to adjust the gain prediction model, prior to applying second processed radar data to the gain prediction model.

14. The radar system controller of claim 12, wherein the processor is further configured to adjust the gain prediction model, prior to applying second processed radar data to the gain prediction model, based on global positioning system (GPS)-oriented marine map data indicating fixed-position object targets within a range of the radar system.

15. The radar system controller of claim 11, wherein the processor is configured to convert the raw radar data into the processed radar data by at least converting the raw radar data into the processed radar data, the processed radar data being defined with respect to a coordinate system having at least one circular-defined dimension.

16. The radar system controller of claim 11, wherein the processor is configured to convert the raw radar data into the processed radar data by at least converting the raw radar data into the processed radar data, the processed radar data being formatted as multi-dimensional image frames converted from an array of radar scanlines.

17. The radar system controller of claim 11, wherein the processor is further configured to perform object identification based on the processed radar data;
wherein the processor is configured to:
receive a plurality of known feature locations for known objects; and
apply the processed radar data to the gain prediction model to determine the gain error from the gain prediction model, the gain prediction model being constructed to determine the gain error to capture radar targets in addition to radar targets for the known objects.

18. A method implemented by a radar system controller configured to be disposed on a marine vessel and interface with a marine radar system to predict a gain error, the method comprising:
receiving, by a processor of the radar system controller, raw radar data from the radar system;
converting the raw radar data into processed radar data;
applying, by the processor, the processed radar data to a radar gain prediction model to determine a gain error, the radar gain prediction model having been generated via a machine learning process involving a convolutional neural network; and
adjusting a gain setting value of the radar system as a feedback input to repeatedly adjust the operation of the radar system based on the gain error, wherein the gain setting value affects content of the raw radar data by controlling amplification of the transmitted radar signals or filtering of the received radar reflection signals.

19. The method of claim 18 further comprising:
receiving a second set of raw radar data;
determining a second gain error; and
adjusting the gain setting value of the radar system based on the second gain error.

20. The method of claim 18 further comprising:
receiving a plurality of known feature locations for known objects; and
applying the processed radar data to the gain prediction model to determine the gain error from the gain prediction model, the gain prediction model being constructed to determine the gain error to capture radar targets in addition to radar targets for the known objects; and
performing object identification based on the processed radar data.
